(19) United States
(12) Patent Application Publication
(10) Pub. No.: US 2002/0125611 A1
(43) Pub. Date: Sep. 12, 2002

(54) Method for integrally manufacturing a shoe with different materials

(76) Inventor: Chun Yin, Changhua Hsien (TW)

Correspondence Address: BACON & THOMAS, PLLC, 625 Slaters Lane, 4th Floor, Alexandria, VA, 22314-1176, US

(21) Appl. No.: 09/799,670

(22) Filed: Mar. 7, 2001

(51) Int. Cl. B29D 31/50

(52) U.S. Cl. 264/244

(57) ABSTRACT

A method for integrally manufacturing a shoe with different materials is disclosed. The main bottom is formed by covering a main template upon a left template. By the groove like a main bottom in the two template, molding material is injected into the shoe groove. For the middle bottom, a right template covers on the main template. By the groove like a middle bottom in the two templates, molding material is injected into the shoe groove. For the shoe pad above the middle bottom, a lower template covers on the main template. In the two templates, a shoe groove like a pad corresponding to the main bottom is formed. Then, molding material is injected into the shoe groove. For a time period, the left templates is opened, and the shoe pad, middle bottom, and main bottom are combined together.

### BACKGROUND OF THE INVENTION

The present invention relates to the manufacturing of a shoe, and especially to a method for integrally manufacturing a shoe with different materials.

With the progress of the technology and the dramatic competitions in the market, the requirement for shoes is more and more severe. Not only the shoes must be made comfortable, but also more materials are required in the manufacturing of the shoe body. With reference to FIGS. 1 and 2, schematic views of prior shoes are illustrated. In general, the shoe body 1 is made of TPR which is tolerable in rubbing. Therefore, most of the manufacturers uses this material for making the main bottom 2 and middle bottom 3 of a shoe. The material TPR is too hard to be as the material of the inner bottom 4 of the shoe body 1 since the user will feel uneasy. In the aforesaid manufacturing process of the shoe body 1, the main bottom 2, middle bottom 3, and inner bottom 4 are made individually and then they are combined by sticking. However, as it is worn for a long time, it is possible to become loose or disintegrate. Therefore, in the aforesaid TPR material, the sticking and assembling in manufacturing have the following disadvantage:

1. Since in the manufacturing process, the main bottom 2, middle bottom 3, and inner bottom 4 are made individually and then are assembled and combined, the manufacturing process is complex so that the producing efficiency is low.

2. Since the TPR is too hard to be suitable as the user wears the shoes, the consumption willing of the users are low.

Therefore, there is an eager demand for a novel method for integrally manufacturing a shoe with different materials which may improve the aforesaid disadvantages.

### SUMMARY OF THE INVENTION

Accordingly, the primary object of the present invention is to provide a method for integrally manufacturing a shoe with different materials. Thereby, the time for machining can be reduced and the damage to the shoe is decreased so that a more comfortable shoes are manufactured.

To achieve above objects, the present invention provides a method for integrally manufacturing a shoe with different materials. The main bottom is formed by covering a main template on a left template. By the groove like a main bottom in the two templates, molding material is injected into the shoe groove. For the middle bottom, a right template covers on the main template. By the groove like a middle bottom in the two templates, molding material is injected into the shoe groove. For the shoe pad above the middle bottom, a lower template covers on the main template. In the two templates, a shoe groove like a shoe pad having a shape corresponding to the middle bottom is formed. Then, molding material is injected into the shoe groove. For a time period, the left template is opened, then the pad, middle bottom and main bottom are combined together.

The various objects and advantages of the present invention will be more readily understood from the following detailed description when read in conjunction with the appended drawing.

### BRIEF DESCRIPTION OF THE DRAWINGS

FIG. 1 is a schematic view of a prior art shoe.

FIG. 2 is another schematic view of a prior art shoe.

FIG. 3 is a plane schematic view of the mold device in the present invention.

FIG. 4 is an assembled schematic view showing the combination of the main template and the left template in the present invention.

FIG. 5 is an assembled schematic view showing the combination of the main template and the right template in the present invention.

FIG. 6 is an assembled schematic view of the main template and the lower template in the present invention.

FIG. 7 is a schematic perspective view of the shoe body in the present invention.

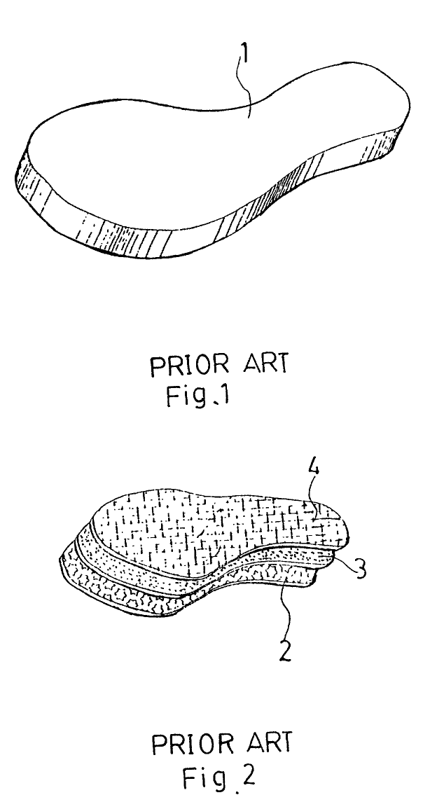

### DETAILED DESCRIPTION OF THE PREFERRED EMBODIMENTS

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

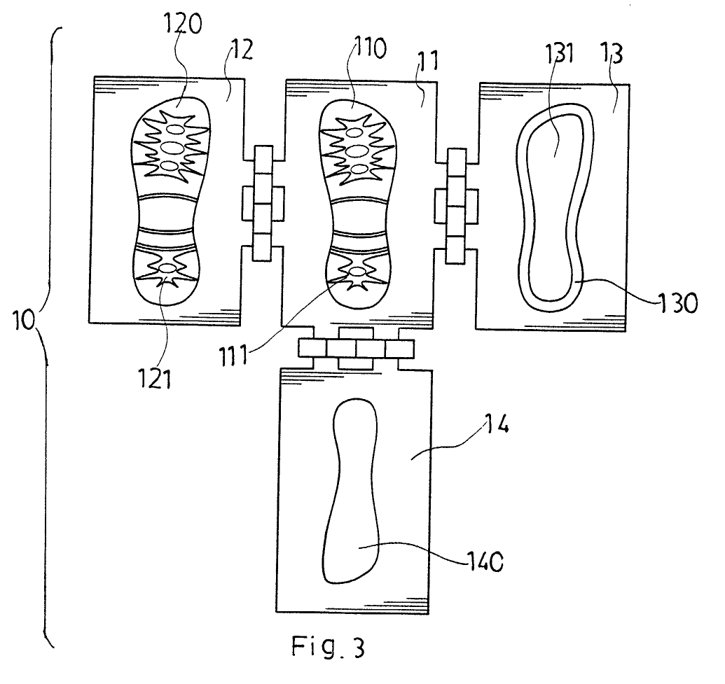

The present invention relates to a method for integrally manufacturing a shoe with different materials, which is illustrated from FIGS. 3 to 7.

At first, referring to FIG. 3, a plane schematic view of the mold device in the present invention is illustrated. In the present invention, a mold device 10 is installed. The mold device 10 can be approximately divided into a main template 11, a left template 12, a right template 13, and a lower template 14 so that the present invention may be manufactured integrally. The main template 11 and left template 12 are installed with shoe grooves 110, 111, 120, 121 which are symmetrical in the main bottom 21 (FIG.7). Besides, the right template 13 is installed with shoe groove 130 having a shape like the middle bottom 23 (FIG.7) and a shoe groove 131 having a shape like a shoe pad 24 (FIG.7). Furthermore, the lower template 14 is installed with a shoe groove 140 symmetrical to the shoe groove 131 of the right template 13.

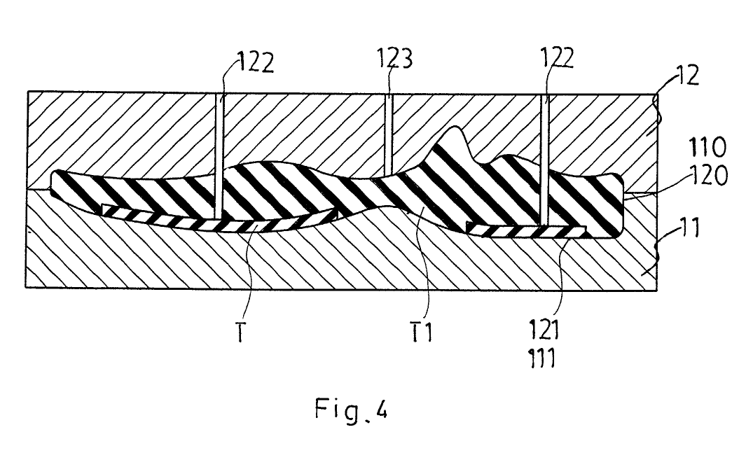

Furthermore, with reference to FIGS. 4 and 7, in the present invention, aforesaid mold device 10 is made with four layers and integrally formed shoe body 20.

At first, the process of the present invention is divided into a first, a second and a third steps so as to integrally make a shoe body 20 with different shapes, materials and colors.

In the first step, the main bottom 21 of the shoe body 20 is formed as shown in FIG. 4, in that the assembled schematic view of the main template 11 and left template 12 of the present invention is illustrated. The left template 12 covers on the main template 11. The left template 12 and main template 11 are installed with symmetric shoe grooves 120 and 110 having a shape like a main bottom 21 and shoe grooves 121 and 111 with textures so that as the left template 12 covers on the main template 11, the inner part of the left template 12 and main template 11 are formed with a shape of main bottom 21. The top of the left template 12 is installed with an injecting hole 122 communicated to the shoe grooves 121 and 111 and another injecting hole 123 communicated with another shoe grooves 120 and 110. The mold materials T and T1 (which are TPR (thermal plastic rubber) for enhancing the rigidity of the shoe body 20) are injected into the shoe grooves 121 and 111 and shoe grooves 120 and 110. After a proper time period is elapsed, the left template 12 is opened so as to be formed with a main bottom 21. Furthermore, the lower side of the main bottom 21 is formed with a texture 22 like the textures of the shoe grooves 111 and 121.

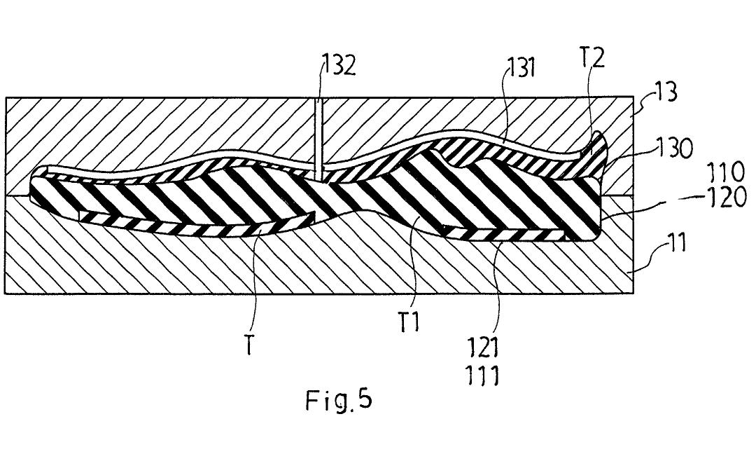

In second step, the middle bottom 23 is made with referring to FIG. 5, in that the assembled schematic view of the main template 11 and right template 13 of the present invention are illustrated. The right template 13 covers on the main template 11. The right template 13 is formed with a shoe groove 130 like the middle bottom 23, after the right template 13 covers on the main template 11, a shape like the middle bottom 23 is formed within the right template 13 and the main template 11. A top of the right template 13 is installed with an injecting hole 132 communicated to the shoe groove 130 so that the mold material T2 (which is TPR for enhancing the rigidity of the shoe body 20) is injected into the shoe groove 130. After a proper time period elapses, the right template 13 is opened and then the middle bottom 23 and the main bottom 21 can be combined as an integral body.

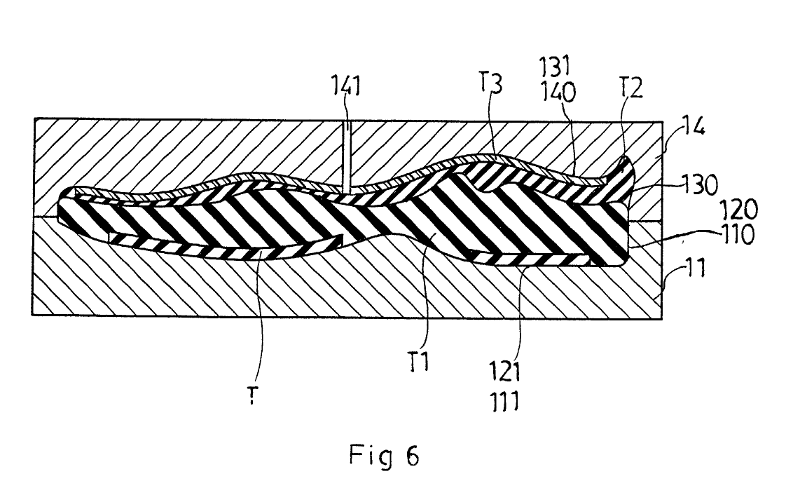

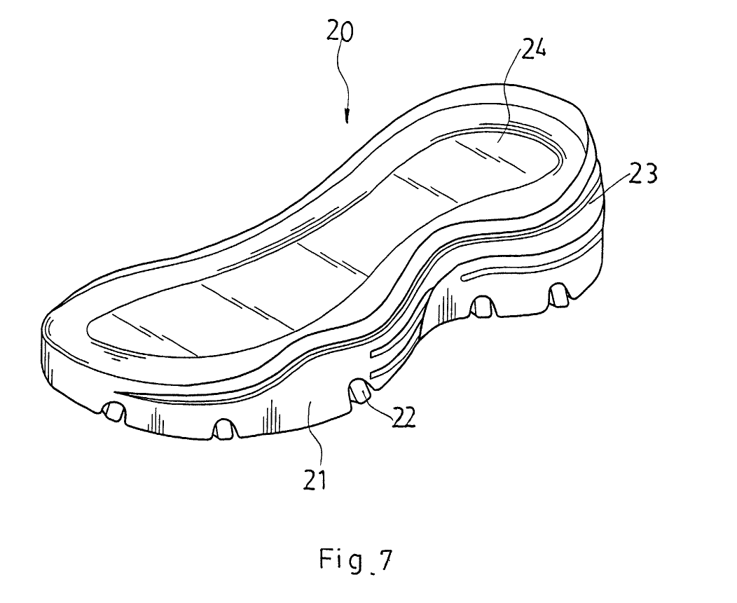

Furthermore, in the third step, the shoe pad 24 above the middle bottom 23 is formed with reference to FIG. 6, in that the assembled schematic view of the main template 11 and lower template 14 according to the present invention are illustrated. The lower template 14 covers on the main template 11. The symmetrical shoe grooves 140 and 131 with a shape like shoe pad 24 are installed in the lower template 14 and right template 13. Therefore, after being covered, shoe grooves 140 and 131 like shoe pad 24 are formed in the lower template 14 and main template 11. The top of the lower template 14 is installed with an injecting hole 141 communicated to the shoe groove 140 and 131. The mold material T3 (which is polyurethane (PU), and has a preferred elasticity by the PU material so that as the user wears the shoes, he (or she) has a comfortable feeling) is injected into the shoe grooves 140 and 131. After a time period elapses, the lower template 14 is opened to be formed as that shown in FIG. 7 in which a schematic view of the shoe body according to the present invention is illustrated. Namely, the shoe body 20 is integrally formed with the shoe pad 24, the middle bottom 23 and main bottom 21.

Through the aforesaid first, second and third steps, the main bottom 21, texture 22, middle bottom 23 and shoe pad 24 in the shoe body 20 of the present invention are formed integrally. While in the prior art, the main bottom 2, middle bottom 3, and inner bottom 4 of the shoe body 1 are formed individually and then they are stuck and assembled, thus the present invention is different from the prior art. By the present invention, the materials of TPR and PU are used integrally in the manufacturing process. This is completely different from the prior art in which the shoe body 1 is made of single material, TPR. In other word, the shoes made by the method for integrally manufacturing a shoe with different materials of the present invention has the following advantages:

1. In the present invention, the shoe body 20 made from the mold device 10 is formed integrally. Therefore, the main bottom 21, texture 22, middle bottom 23 and shoe pad 24 are formed integrally. They will not become loose and separate from each other because of being used for a long time period. This is to say the present invention has a preferred tolerance and good applications.

2. The shoe body 20 of the present invention can be varied according to the requirement of the users. That is, by the main template 11 and left template 12 in the mold device 10, the main bottom 21, texture 22, middle bottom 23 and pad 24 in the mold device 10 have different colors.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for integrally manufacturing a shoe with different materials, a mold device being used and having a main template, a left template, a right template, and a lower template; wherein by the mold device, the method comprising three steps so as to integrally manufacture a shoe with different materials:
(1) the left template covers on the main template; the left template and main template are installed with shoe grooves so that as the left template covers on the main template, a top of the left template is installed with an injecting hole communicated to the shoe grooves and another injecting hole communicated with another shoe grooves; molding materials are injected into these shoe grooves; after a proper time period elapses, the left template is opened so as to be formed with a main bottom; furthermore, a lower side of the main bottom is formed with a texture;
(2) the right template covers on the main template; the right template is formed with a shoe groove, after the right template covers on the main template, a shape like the middle bottom is formed within the right template and the main template; a top of the right template is installed with an injecting hole communicated to the shoe groove so that a mold material is injected into the shoe groove; after a proper time period is elapsed, the right template is opened and then the middle bottom and the main bottom can be combined as an integral body;
(3) the lower template covers on the main template; symmetrical shoe grooves with a shape like shoe pad are formed in the lower template and right template; therefore, after being covered, shoe grooves like shoe pad are formed in the lower template and main template; a top of the lower template is installed with an injecting hole communicated to the shoe groove; a mold material is injected into the shoe grooves; after a time period elapses, the lower template is opened; and therefore, the shoe body is integrally formed with the middle bottom and main bottom.

2. The method for integrally manufacturing a shoe with different materials as claimed in claim 1, wherein the left template and main template are formed with symmetric shoe grooves having a shape like a main bottom; the right template is formed with a shoe groove like the middle bottom and a further shoe groove like shoe pad; further, the left template is formed with shoe groove symmetrical to the shoe groove of the right template.
